(19) United States
(12) Patent Application Publication
(10) Pub. No.: US 2011/0051156 A1
(43) Pub. Date: Mar. 3, 2011

(54) IMAGE PROCESSING APPARATUS, IMAGE PROCESSING METHOD, AND COMPUTER READABLE MEDIUM

(75) Inventors: Kouji YORIMOTO, Saitama (JP); Yasuo Komatsu, Saitama (JP); Kiyoshi Une, Saitama (JP); Takumi Nishikata, Saitama (JP)

(73) Assignee: FUJI XEROX CO., LTD., Tokyo (JP)

(21) Appl. No.: 12/758,313

(22) Filed: Apr. 12, 2010

(30) Foreign Application Priority Data
Sep. 2, 2009 (JP) 2009-203037

(51) Int. Cl. H04N 1/60

(52) U.S. Cl. 358/1.9

(57) ABSTRACT

According to an aspect of the invention, an image processing apparatus includes a first calculating unit, a second calculating unit, and a control unit. The first calculating unit calculates, for each print subject image, consumptions of recording materials when the print subject image is printed based on image data of the print subject image, a first value of a first element and a second value of a second element. The second calculating unit calculates a first consumption variation range of the recording materials that corresponds to a first adjustment range of the first element and a second consumption variation range of the recording materials that corresponds to a first adjustment range of the second element. The control unit controls a display device so that the display device displays the first adjustment range and the first variation range and displays the second adjustment range and the second variation range.

### CROSS-REFERENCE TO RELATED APPLICATIONS

This application is based upon and claims priority under 35 USC 119 from Japanese Patent Application No. 2009-203037, filed Sep. 2, 2009.

### BACKGROUND

1. Technical Field

The present invention relates to an image processing apparatus, an image processing method, and a computer readable medium.

2. Related Art

There are printers that are provided with an image quality adjusting function for obtaining desired image quality in terms of lightness, chroma, etc. In such printers, the consumptions of recording materials may be reduced depending on results of image quality adjustments in which the user adjusts the values of lightness, chroma, etc. using the image quality adjusting function.

### SUMMARY OF THE INVENTION

According to an aspect of the invention, an image processing apparatus includes a first calculating unit, a second calculating unit, and a control unit. The first calculating unit calculates, for each print subject image, consumptions of recording materials when the print subject image is printed based on image data of the print subject image, a first value of a first element and a second value of a second element. The second calculating unit calculates a first consumption variation range of the recording materials that corresponds to a first adjustment range of the first element and a second consumption variation range of the recording materials that corresponds to a first adjustment range of the second element. The control unit controls a display device so that the display device displays the first adjustment range and the first variation range and displays the second adjustment range and the second variation range.

### BRIEF DESCRIPTION OF THE DRAWINGS

Exemplary embodiments of the invention will be described in detail based on the following figures, wherein:

FIG. 1 is a block diagram showing functions of an image processing apparatus according to a first embodiment;

FIG. 2 is a flowchart of an image quality information setting process which is executed by the image processing apparatus according to the first embodiment;

FIG. 3 shows an example image quality adjustment picture used in the first embodiment;

FIG. 4 illustrates, in a more detailed manner, the image quality adjustment picture of FIG. 3;

FIG. 5 shows an example image quality adjustment picture which is displayed when image quality adjustments have been performed using the image quality adjustment picture of FIG. 3;

FIG. 6 shows an example color balance adjustment picture used in the first embodiment;

FIG. 7 is a block diagram showing a hardware configuration of the image processing apparatus according to the first embodiment;

FIG. 8 shows example print setting property used in a second embodiment;

FIG. 9 illustrates an example procedure for changing the setting type of a recommendable image quality type in the print setting property of FIG. 8;

FIG. 10 illustrates an example procedure for changing the setting mode of a color mode in the print setting property of FIG. 8;

FIG. 11 illustrates an example procedure for changing the setting mode of a print mode in the print setting property of FIG. 8;

FIG. 12 illustrates an example procedure for changing the setting mode of an image quality adjustment mode in the print setting property of FIG. 8; and

FIG. 13 also illustrates an example procedure for changing the setting mode of the image quality adjustment mode in the print setting property of FIG. 8.

### DETAILED DESCRIPTION

Exemplary embodiments of the present invention will be hereinafter described in detail with reference to the drawings. In the drawings for description of the embodiments, the same constituent elements are given the same reference symbol as a general rule and will not be described repeatedly.

### First Embodiment

An image processing apparatus according to a first embodiment will be described below.

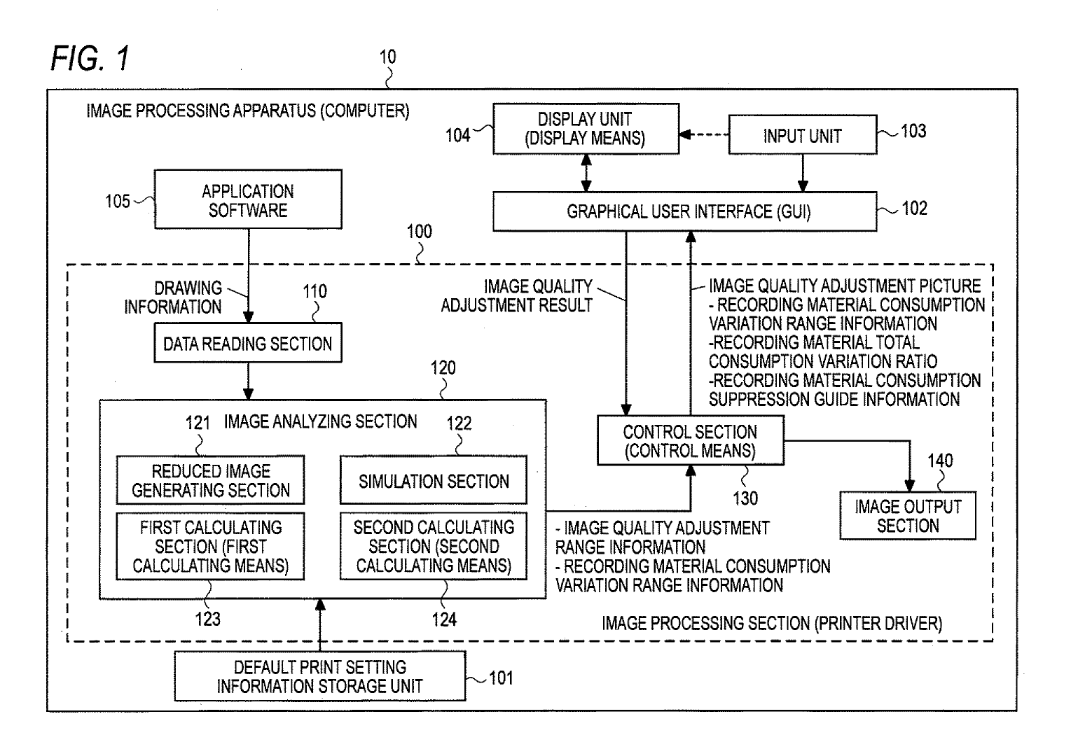

As shown in FIG. 1, the image processing apparatus 10 is provided with an image processing section 100, a default print setting information storage unit 101, a graphical user interface 102, an input unit 103, and a display unit 104.

Default setting values relating to printing (hereinafter referred to as “default print setting information”) are stored in the default print setting information storage unit 101.

For example, the default print setting information includes plural setting items such as a size of a recording medium such as a sheet, the number of copies, a sheet direction, single-sided printing or double-sided printing, image quality information, an image quality type, a color mode, a print mode, and an image quality adjustment mode.

The image quality information includes a value(s) of one or more image-quality-determining elements (parameters) such as lightness, chromes, hue, color balance, sharpness, and contrast and information indicating adjustment ranges of the respective elements. The values of the individual parameters are changed by the user. The adjustment range of each element is a preset, fixed range from a first value to a second value and includes a default setting value.

For example, the image quality type includes parameters representing respective options such as “standard (default),” “photograph,” “presentation,” Web page,” “CAD,” and “POP.”

For example, the color mode includes parameters representing respective options such as “color” and “black and white.”

For example, the print mode includes parameters representing respective options such as “standard (default),” “high image quality,” and “high resolution.”

For example, the image quality adjustment mode includes parameters representing respective options such as “recommendation (default),” “ICM adjustment,” “CMS adjustment,” “no color conversion.”

When the value of at least one setting item among the plural setting items of the default print setting information is changed from its default setting value, the default print setting information becomes such that not all setting items have the default setting values. Therefore, default print setting information including a setting item(s) whose value has been changed from its default setting value is defined as print setting information.

The image processing section 100 is provided with a data reading section 110, an image analyzing section 120, a control section 130, and an image output section 140.

If receiving a print instruction from an application software, the data reading section 110 reads drawing information (print data) of a print-instructed print subject from the application software 105, generates raster image data (print data) of respective colors (red (R), green (G), and blue (B)) based on the read-out drawing information, and outputs the generated RGB raster image data (print data) to an image analyzing section 120.

The image analyzing section 120, which is provided with a reduced image generating section 121, a simulation section 122, a first calculating section 123, and a second calculating section 124, performs reduced image generation processing, simulation processing, and calculation processing.

The reduced image generating section 121 generates a reduced image, that is, reduces an image of the print subject RGB image data into an image having a predetermined image size or reduces it at a predetermined reduction ratio. The thus-generated reduced image is supplied to the control section 130.

The simulation section 122 performs, on the RGB image data, color conversion processing (for color conversion from the RGB color space to the CMYK color space) according to the image quality information and a color space conversion multi-dimensional (e.g., three-dimensional) look-up table (LUT), and performs, on color-converted image data in the CMYK color space, tone correction processing according to a tone reproduction curve (TRC). A result of this processing is CMYK image data. That is, the image analyzing section 120 simulates image processing such as color conversion processing and tone correction processing to be performed by a control means such as a controller of an image forming apparatus such as a printer.

The first calculating section 123, which has functions of first calculating means, calculates, for each print subject image, consumptions of the recording materials based on image data of the print subject and a predetermined value(s) (default setting value(s)) of one or more image-quality-determining elements. The calculation of consumptions of the recording materials will be described later in detail.

The second calculating section 124, which has functions of second calculating means, calculates, for each image-quality-determining element, a consumption variation range of the recording materials that corresponds to the adjustment range of the image-quality-determining element. The calculation of a consumption variation range of the recording materials will be described later in detail.

The control section 130, which has functions of control means, performs the following processing (1) to processing (4):

(1) The control section 130 performs a control for displaying, on the display unit 104, for each image-quality-determining element, information indicating an adjustment range (image quality adjustment range) of the image-quality-determining element (hereinafter referred to as “image quality adjustment range information”) and information indicating a consumption variation range of the recording materials (hereinafter referred to as “recording material consumption variation range information”) in such a manner that they are correlated with each other.

(2) When the value of at least one of the one or more image-quality-determining elements has been adjusted, the control section 130 performs a control for calculating a variation ratio of the total consumption of the recording materials (hereinafter referred to as “recording material total consumption variation ratio”) that corresponds to value(s), after the adjustment, of the one or more image-quality-determining elements and displaying the calculated recording material total consumption variation ratio on the display unit 104.

(3) The control section 130 performs a control for displaying, on the display unit 104, information indicating guides for suppressing the consumption of the recording materials which relates to adjustment of the one or more image-quality-determining elements (hereinafter referred to as “recording material consumption suppression guide information”).

(4) When receiving an image quality adjustment end instruction from the user, the control section 130 outputs print setting information including image quality information and the print subject image data to the image output section 140.

The image output section 140 issues a print request to a printer (not shown) by outputting a print job of the received print setting information and print subject image data.

The graphical user interface (hereinafter abbreviated as GUI) 102, which has GUI functions, outputs, to the display unit 104, display information such as a print dialog (property) provided by the application software 105, for example, print setting property provided by the image processing section 100, or an image quality adjustment picture. And the GUI 102 outputs, to the image processing section 100, input information that has been input through the print dialog, print setting property, or image quality adjustment picture.

The input unit 103, which is an input device, for example, allows the user to input information such as an instruction to the effect that the user is going to make print setting or image quality adjustments through print setting property or an image quality adjustment picture being displayed on the display unit 104, an instruction relating to selection of an option, or an instruction relating to setting of a value.

The display unit 104, which has functions of display means, displays display information such as print setting property, an image quality adjustment picture, or the like which is supplied from the GUI 102. The display unit 104 is a display device, for example.

In this specification, it is assumed that the image processing section 100 is a printer driver. However, in the invention, the image processing section 100 is not limited to a printer driver and may be dedicated software, firmware, or hardware.

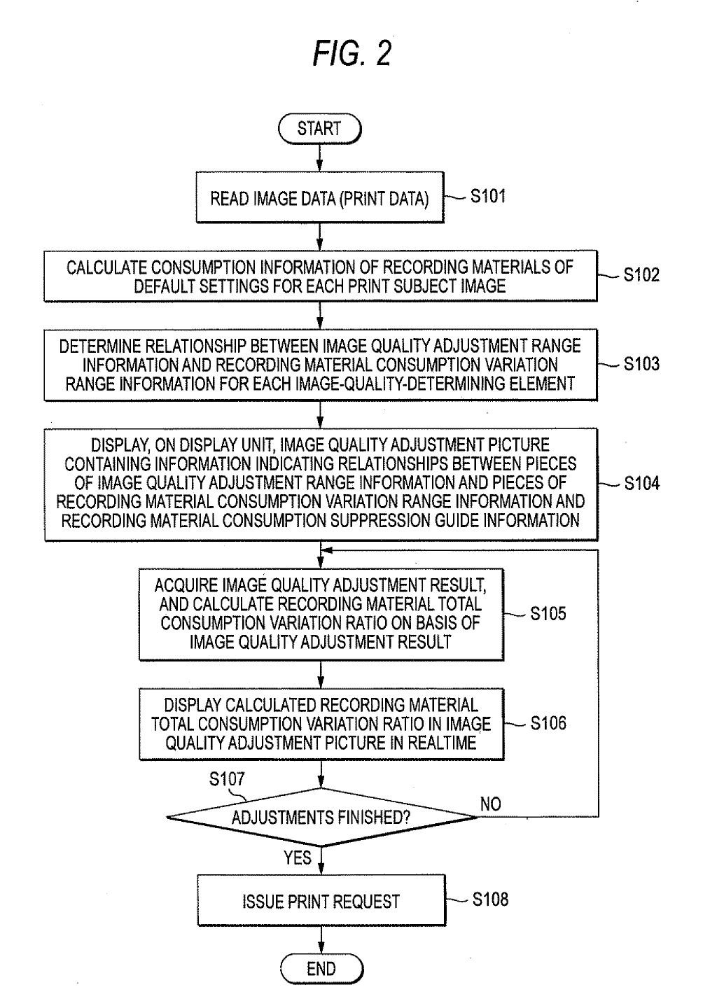

Next, an image quality information setting process which is executed by the image processing apparatus 10 will be described with reference to FIG. 2.

When a print instruction is received from the application software 105, in the image processing section 100 as a printer driver, at step S101 the data reading section 110 reads drawing information (print data) of a print-instructed print subject from the application software 105. The data reading section 110 generates RGB raster image data (print data) from the read-out drawing information and outputs the generated image data to the image analyzing section 120.

The image analyzing section 120 reads the default print setting information from the default print setting information storage unit 101.

At step S102, the first calculating section 123 calculates, for each print subject image (image data), consumptions of the recording materials based on the print subject image data and predetermined values (default values) of one or more image-quality-determining elements.

The processing of calculating consumptions of the recording materials which is performed by the first calculating section 123 will be described below.

When receiving image quality information, having default setting values, of the default print setting information from the first calculating section 123, the simulation section 122 converts the RGB image data in the RGB color space into image data in the CMYK color space according to the received image quality information and a multi-dimensional (e.g., three-dimensional) look-up table (LUT) and performs a tone correction on the color-converted image data in the CMYK color space according to a tone reproduction curve (TRC). Resulting CMYK image data is output to the first calculating section 123.

The RGB color space is a color space in which a color is represented by the individual colors of red (R), green (G), and blue (B).

The CMYK color space is a color space in which a color is represented by the individual colors of cyan (C), magenta (M), yellow (Y), and block (K).

The first calculating section 123 receives the simulation result, that is, the CMYK image data, from the simulation section 122, generates pieces of output plane information (bit masks) of the respective colors (CMYK) based on the CMYK image data, and calculates image densities of images of the respective colors (hereinafter referred to as “CMYK image densities”) based on the generated pieces of output plane information of the respective colors. The CMYK image densities are defined as CMYK image densities with application of the default settings.

In this specification, the CMYK image densities with application of default settings are defined as the above-described consumptions of the recording materials.

A description will now be made of the calculation of CMYK image densities (consumptions of the recording materials) with application of default settings which is performed by the first calculating section 123.

Let Ca, Ma, Ya, and Ka represent image densities of C, M, Y, and K images of a CMYK image A which is expressed by the C, M, Y, and K colors of the CMYK color space. The first calculating section 123 calculates CMYK image densities by calculating the following equations (Formulae 1). It is assumed that the CMYK image A has an image size which is defined by parameters “width” (horizontal size) and “height” (vertical size).

$$Ca = {\sum }_{x = 0}^{width - 1} {\sum }_{y = 0}^{height - 1} {P}_{C} ( x , y ) \\ Ma = {\sum }_{x = 0}^{width - 1} {\sum }_{y = 0}^{height - 1} {P}_{M} ( x , y ) \\ Ya = {\sum }_{x = 0}^{width - 1} {\sum }_{y = 0}^{height - 1} {P}_{Y} ( x , y ) \\ Ka = {\sum }_{x = 0}^{width - 1} {\sum }_{y = 0}^{height - 1} {P}_{K} ( x , y ) \qquad [ Formulae 1 ]$$

In the above equations, P_{C}(x, y), P_{M}(x, y), P_{Y}(x, y), and P_{K}(x, y) represent a C-color value, an M-color value, a Y-color value, and a K-color value, respectively, of the pixel having the coordinates (x, y) of the image A.

When the CMYK image densities (consumptions of the recording materials) have been calculated by the first calculating section 123 in the above-described manner, at step S103 (see FIG. 2) the second calculating section 124 determines a relationship between the image quality adjustment range information and a recording material consumption variation range information. That is, the second calculating section 124 calculates a consumption variation range of the recording materials which corresponds to the adjustment range of each element.

A description will now be made of the processing of calculating a consumption variation range of the recording materials which is performed by the second calculating section 124.

The second calculating section 124 changes the value of only an element of attention among the image quality information, that is, the one or more image-quality-determining elements, of the default print setting information from the default setting value to the first value in the adjustment range (image quality adjustment range). The values of the elements other than the element of attention are not changed, that is, they are kept equal to the default setting values which are included in the adjustment ranges. Default print setting information the value of whose element of attention has been changed is made print setting information.

For example, if the element of attention is lightness which is one of the image-quality-determining elements such as lightness, chrome, hue, color balance, sharpness, and contrast and the adjustment range of lightness is from “−100” to “+100,” “−100” and “+100” are employed as the first value and the second value, respectively. “+100” and “−100” may be employed as the first value and the second value, respectively. For every image-quality-determining element, the default setting value is set to “0.” Under these preconditions, the second calculating section 124 changes the value of only the element of attention (lightness) among the image quality information, that is, the one or more image-quality-determining elements, from the default value “0” to the first value “−100” of the adjustment range.

The second calculating section 124 supplies the simulation section 122 with image quality information in which the element of attention has the first value, acquires a simulation result (CMYK image data) from the simulation section 122, generates pieces of output plane information of the respective colors (CMYK) based on the CMYK image data, and calculates CMYK image densities based on the pieces of output plane information of the respective colors. The thus-obtained CMYK image densities are defined as first CMYK image densities with application of the print settings.

Then, the second calculating section 124 changes the value of only the element of attention among the image quality information, that is, the one or more image-quality-determining elements, of the default print setting information from the default setting value to the second value in the adjustment range. The values of the elements other than the element of attention are not changed, that is, they are kept equal to the default setting values which are included in the adjustment ranges. Default print setting information the value of whose element of attention has been changed is made print setting information.

For example, under the above-described preconditions, the second calculating section 124 changes the value of only the element of attention lightness among the image quality information, that is, the one or more image-quality-determining elements, from the default value “0” to the second value “+100” of the adjustment range.

The second calculating section 124 supplies the simulation section 122 with image quality information in which the element of attention has the second value, acquires a simulation result (CMYK image data) from the simulation section 122, generates pieces of output plane information of the respective colors (CMYK) based on the CMYK image data, and calculates CMYK image densities based on the pieces of output plane information of the respective colors. The thus-obtained CMYK image densities are defined as second CMYK image densities with application of the print settings.

Then, the second calculating section 124 calculates a first consumption ratio of the recording materials based on the CMYK image densities with application of the default settings calculated by the first calculating means 123 and the first CMYK image densities with application of the print settings calculated above. And the second calculating section 124 calculates a second consumption ratio of the recording materials based on the CMYK image densities with application of the default settings calculated by the first calculating means 123 and the second CMYK image densities with application of the print settings calculated above.

The first consumption ratio (in percent) of the recording materials and the second consumption ratio (in percent) of the recording materials are calculated according to the following equations:

(First consumption ratio of recording materials)={(first CMYK image density with application of print settings)/(CMYK image density with application of default settings)−1}·100

(Second consumption ratio of recording materials)={(second CMYK image density with application of print settings)/(CMYK image density with application of default settings)−1}·100

That is, the first (or second) consumption ratio of the recording materials is an increase or decrease from a consumption ratio (100%) of the recording materials corresponding to the CMYK image density with application of the default settings.

The second calculating section 124 employs, as adjustment range information (image quality adjustment range information), the adjustment range for the element of attention from the first value to the second value. And the second calculating section 124 employs, as variation range information indicating a consumption variation range of the recording materials (recording material consumption variation range information), a range from the first consumption ratio of the recording materials that has been calculated for the first value to the second consumption ratio of the recording materials that has been calculated for the second value. The second calculating section 124 outputs the image quality adjustment range information and the recording material consumption variation range information to the control section 130.

The second calculating section 124 generates image quality adjustment range information and recording material consumption variation range information in the above-described manner for all of the image-quality-determining elements such as lightness, chroma, hue, color balance, sharpness, and contrast, and outputs them to the control section 130.

After performing the above processing, the image analyzing section 120 outputs the print subject image data and the default print setting information to the control section 130.

At step S104 (see FIG. 2), the control section 130 displays, on the display unit 104, via the GUI 102, an image quality adjustment picture containing a reduced image supplied from the reduced image generating section 121, the pieces of image quality adjustment range information and the pieces of recording material consumption variation range information (i.e., information indicating relationships between the pieces of image quality adjustment range information and the pieces of recording material consumption variation range information) supplied from the second calculating section 124, and recording material consumption suppression guide information (i.e., information indicating guides for suppression of the consumption of the recording materials) relating to adjustment of the one or more image-quality-determining elements.

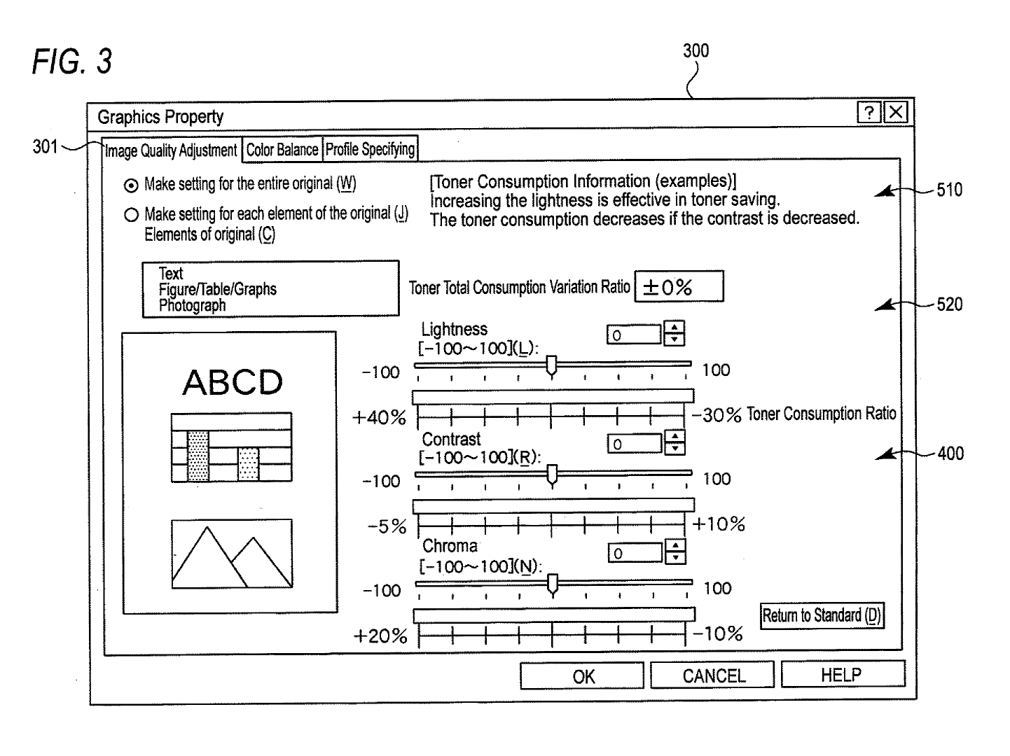

FIG. 3 shows an example image quality adjustment picture. As shown in FIG. 3, recording material consumption variation range information 400, recording material consumption suppression guide information 510, and recording material total consumption variation ratio information 520 are displayed in the image quality adjustment picture 300.

The image quality adjustment picture 300 is a picture of a state that an item (tab) “image quality adjustment” 301 is selected or an initial state.

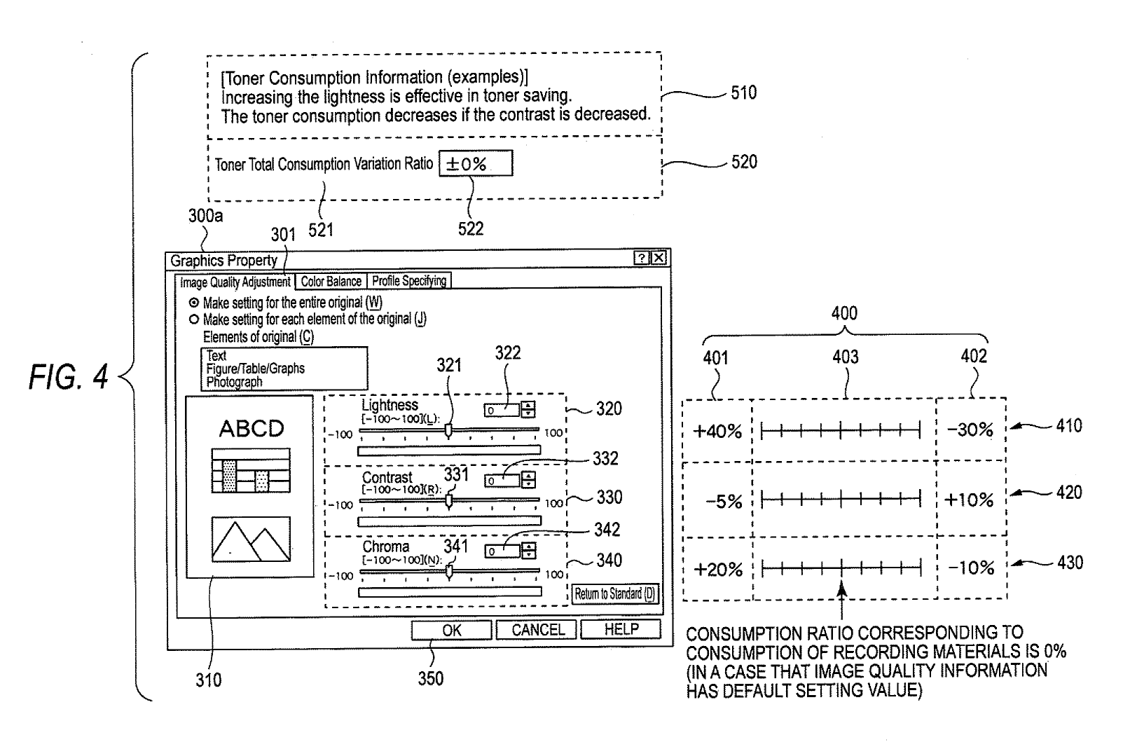

For the convenience of description, the image quality adjustment picture 300 of FIG. 3 will be described in such a manner that it will be divided into the recording material consumption variation range information 400, the recording material consumption suppression guide information 510, the recording material total consumption variation ratio information 520, and an image quality adjustment picture 300a in which none of the pieces of information 400, 510, and 520 are displayed. FIG. 4 shows the image quality adjustment picture 300 as so divided.

In the example image quality adjustment picture 300a shown in FIG. 4, reference numeral 310 denotes a reduced image, numeral 320 denotes a lightness adjustment item to be used for adjustment of the lightness, numeral 330 denotes a contrast adjustment item to be used for adjustment of the contrast, and numeral 340 denotes a chroma adjustment item to be used for adjustment of the chroma.

The user adjusts the lightness by moving a slide bar position mark 321 of the lightness setting item 320 rightward (toward +100) or leftward (toward −100). An adjusted lightness value is displayed in a lightness value indication box 322. The lightness adjustment range is from “−100” to “+100.” At a time point when the image quality adjustment picture 300 is displayed, the slide bar position mark 321 is located at the center corresponding to the lightness initial setting value “0.”

The user adjusts the contrast by moving a slide bar position mark 331 of the contrast adjustment item 330 rightward (toward +100) or leftward (toward −100). An adjusted contrast value is displayed in a contrast value indication box 332. The contrast adjustment range is from “−100” to “+100.” At a time point when the image quality adjustment picture 300 is displayed, the slide bar position mark 331 is located at the center corresponding to the contrast initial setting value “0.”

Furthermore, the user adjusts the chroma by moving a slide bar position mark 341 of the chroma adjustment item 340 rightward (toward +100) or leftward (toward −100). An adjusted chroma value is displayed in a chroma value indication box 342. The chroma adjustment range is from “−100” to “+100.” At a time point when the image quality adjustment picture 300 is displayed, the slide bar position mark 341 is located at the center corresponding to the chroma initial setting value “0.”

The recording material consumption variation range information 400 consists of lightness recording material consumption variation range information 410, contrast recording material consumption variation range information 420, and chroma recording material consumption variation range information 430.

In the recording material consumption variation range information 400, the pieces of recording material consumption variation range information 410, 420, and 430 of the respective image-quality-determining elements each include a first consumption ratio 401, a second consumption ratio 402, and a recording material consumption variation range scale 403.

If the user pays attention to the lightness, for example, and moves the slide bar position mark 321 to a desired value in the lightness adjustment range (−100 to +100) by manipulating the input unit 103 (i.e., if the user adjusts the lightness to the desired value), the recording material consumption ratio takes a value corresponding to the above desired value in the lightness recording material consumption variation range (+40% to −30%). The recording material consumption ratio is calculated in the same manner as the first recording material consumption ratio or the second recording material consumption ratio is calculated (described above).

For example, if the user pays attention to the lightness and moves the slide bar position mark 321 leftward to a lightness value “−100,” the first recording material consumption ratio 401 takes a value “+40%.” If the user moves the slide bar position mark 321 rightward to a lightness value “+100,” the second recording material consumption ratio 402 takes a value “−30%.” That is, when the lightness is varied from “−100” to “+100” in the lightness adjustment range, the consumption ratio of the recording materials (toner consumption ratio) varies from “+40%” to “−30%.”

The recording material consumption suppression guide information 510 is the details of example guides for suppression of the consumption of the recording materials. Taking the details of the recording material consumption suppression guide information 510, the user tries to suppress the consumption of the recording materials by adjusting one of the image quality adjustment items which are the lightness adjustment item 320, the contrast adjustment item 330, and the chrome adjustment item 340.

The recording material total consumption variation ratio information 520 consists of an item name “recording material total consumption variation ratio” (toner total consumption variation ratio) 521 and a recording material total consumption variation ratio indication box 522 where an actual recording material total consumption variation ratio (toner total consumption variation ratio) is to be displayed. At a time point when the image quality adjustment picture 300 is displayed, a value “0%” is shown in the recording material total consumption variation ratio indication box 522 as a recording material total consumption variation ratio. Where the recording materials are toners, it can be said that the recording material total consumption variation ratio is a toner total consumption variation ratio.

In the first embodiment, the recording material consumption variation range information 400, the recording material consumption suppression guide information 510, the recording material total consumption variation ratio information 520 are pieces of information relating to the consumption of the recording materials.

When the user has adjusted at least one of the image quality adjustment items which are the lightness adjustment item 320, the contrast adjustment item 330, and the chroma adjustment item 340 by manipulating the input unit 103, a value of the adjusted image quality adjustment item is supplied to the control section 130 of the image processing section 100 via the GUI 102.

At step S105 (see FIG. 2), the control section 130 calculates a recording material total consumption variation ratio based on the image quality adjustment result (a value, after the image quality adjustment, of one or more elements) obtained via the GUI 102. At step S106, the control section 130 displays the calculated recording material total consumption variation ratio in the recording material total consumption variation ratio indication box 522 of the image quality adjustment picture 300 in real-time.

For example, if only the lightness adjustment item 320 has been adjusted, the control section 130 calculates a recording material total consumption variation ratio (toner total consumption variation ratio) in the lightness adjustment range (=100 to +100). It is noted that the value in the lightness adjustment range and the recording material total consumption variation ratio (toner total consumption variation ratio) do not always have a linear relationship (Y=aX).

The control section 130 alters the image quality information of the default print setting information or the print setting information based on the acquired image quality adjustment result (the value, after the image quality adjustment, of one or more elements). If the image quality adjustment result acquired this time is a first one, the image quality information of the default print setting information is altered. In this case, if a default setting value of the default print setting information is altered, the default print setting information is changed to print setting information. On the other hand, if the image quality adjustment result acquired this time is a second or later one, the image quality information of the print setting information is altered.

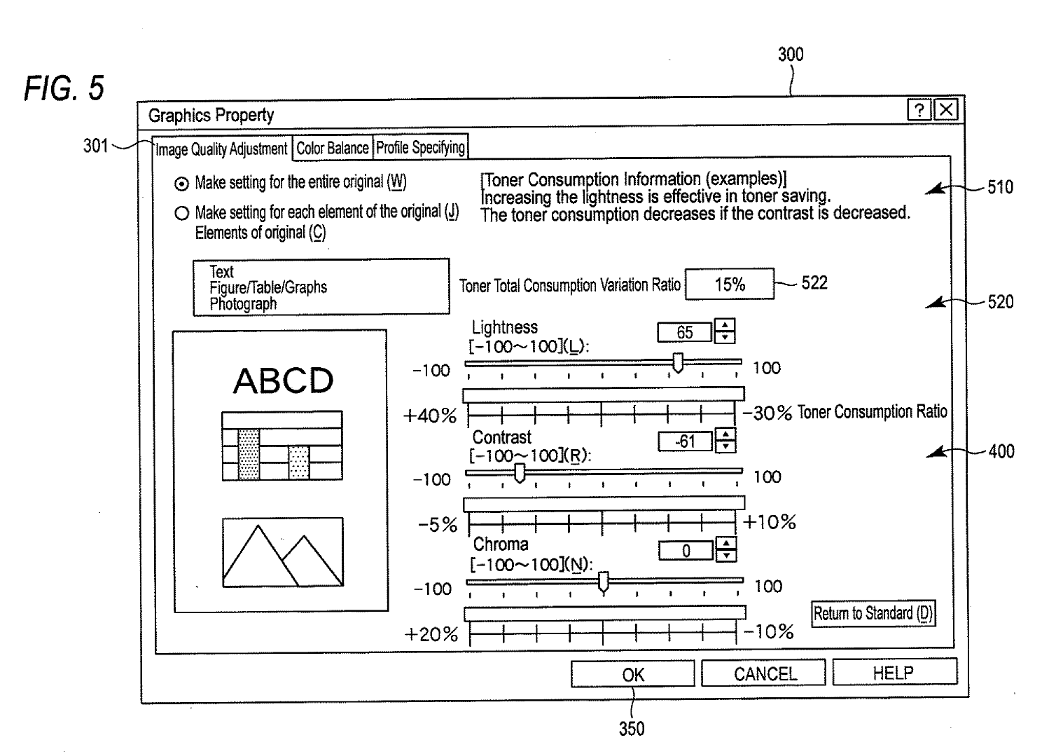

FIG. 5 shows an example image quality adjustment picture 300 which is displayed when the lightness adjustment item 320 and the contrast adjustment item 330 have been adjusted from the state of the image quality adjustment picture 300 of FIG. 3 (also see FIG. 4). In the image quality adjustment picture 300 of FIG. 5, the lightness and contrast are set at values “+65,” and “−61,” respectively, and a recording material total consumption variation ratio (toner total consumption variation ratio) “−15%” is shown in the recording material total consumption variation ratio indication box 522.

At step S107 (see FIG. 2), the control section 130 judges whether the image quality adjustments have finished or not depending on whether or not it has received, via the GUI 102, an image quality adjustment result and a notice to the effect that an OK button 350 has been pressed.

If judging at step S107 that the image quality adjustments have not finished yet (only an image quality adjustment result has been received), the control section 130 returns to step S105. On the other hand, if judging at step S107 that the image quality adjustments have finished (an image quality adjustment result and a notice to the effect that the OK button 350 has been pressed have been received), the control section 130 outputs post-image-quality-adjustment print setting information and the print subject image data to the image output section 140.

At step S108, the image output section 140 issues a print request to the printer (not shown) by outputting a print job of the received print setting information and print subject image data.

To adjust the color balance which is one of the image-quality-determining elements, the user selects an item (tab) “color balance” 302 in the image quality adjustment picture 300 of FIG. 5.

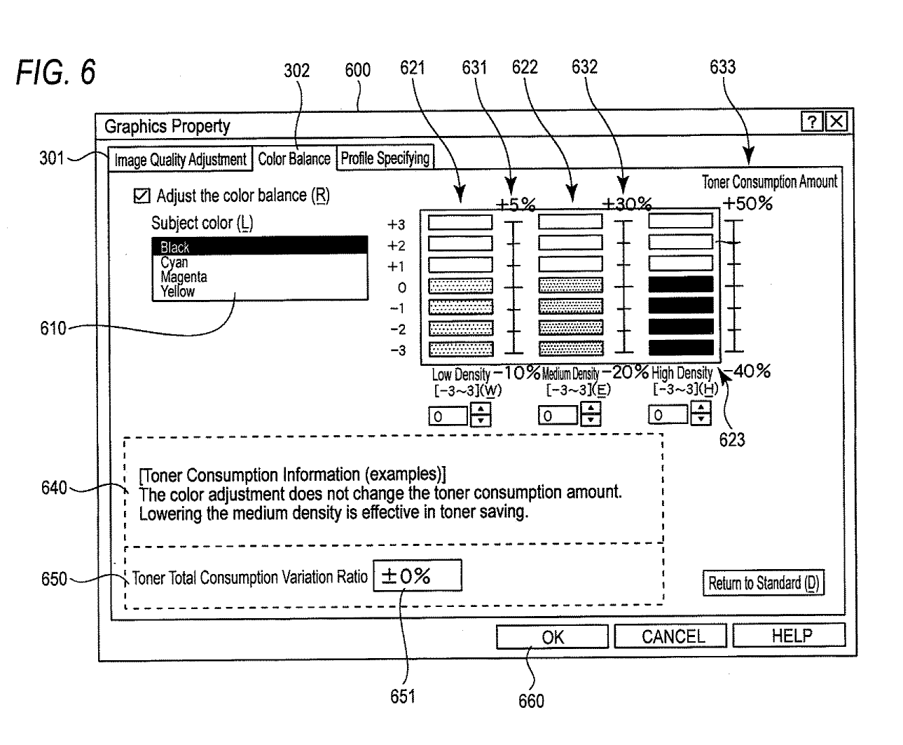

In response, the image quality adjustment picture 300 being displayed on the display unit 104 is changed to a color balance adjustment picture 600 shown in FIG. 6. The color balance adjustment picture 600 of FIG. 6 is a picture in an initial state.

In the example picture 600 of FIG. 6, reference numeral 610 denotes a color specifying box to be used for specifying a subject color of the color balance adjustment. Reference numeral 621 denotes a low-density adjustment item to be used for a low-density adjustment, numeral 622 denotes a medium-density adjustment item to be used for a medium-density adjustment, and numeral 623 denotes a high-density adjustment item to be used for a high-density adjustment. Reference numerals 631-633 denote pieces of recording material consumption variation range information corresponding to the respective density adjustment items 621-623. Reference numeral 640 denotes recording material consumption suppression guide information, and numeral 650 denotes recording material total consumption variation ratio information.

Color names “black,” “cyan,” “magenta,” and “yellow” are shown in the color specifying box 610, and the user selects a desired color as a subject of the color balance adjustment by manipulating the input unit 103. In this example, black is selected in the initial state (default setting).

In each of the low-density adjustment item 621, the medium-density adjustment item 622, and the high-density adjustment item 623, the adjustment range is “−3” to “+3” and the density is set at a default setting value “0.”

Recording material consumption variation range information 631 having a recording material consumption variation range from “−10%” to “+5%” is displayed so as to correspond to the low-density adjustment item 621, recording material consumption variation range information 632 having a recording material consumption variation range from “−20%” to “+30%” is displayed so as to correspond to the medium-density adjustment item 622, and recording material consumption variation range information 633 having a recording material consumption variation range from “−40%” to “+50%” is displayed so as to correspond to the high-density adjustment item 623.

The recording material consumption suppression guide information 640 is recording material consumption suppression guides for the case that black is selected as a subject color of the color balance adjustment.

The recording material total consumption variation ratio information 650 is such that a recording material total consumption variation ratio (toner total consumption variation ratio) corresponding to density values of the density adjustment items 621-623 is displayed in a recording material total consumption variation ratio indication box 651. In this example, since the density values of the density adjustment items 621-623 are default setting values “0,” a recording material total consumption variation ratio “0%” is shown in the recording material total consumption variation ratio indication box 651.

If the user selects a subject color from the colors in the color specifying box 610 and performs a density adjustment (image quality adjustment) for at least one of the density adjustment items 621-623 in the color balance adjustment picture 600 of FIG. 6 by manipulating the input unit 103, the control section 130 calculates a recording material total consumption variation ratio corresponding to an image quality adjustment result and displays, via the GUI 102, the calculated recording material total consumption variation ratio in the recording material total consumption variation ratio indication box 651 of the color balance adjustment picture 600 being displayed on the display unit 104.

If an OK button 660 is pressed, density values of the density adjustment items 621-623 in the color balance adjustment picture 600 are supplied to the control section 130 of the image processing section 100 via the GUI 102.

Recording material consumption variation ranges of the lightness recording material consumption variation range information 410, the contrast recording material consumption variation range information 420, and the chroma recording material consumption variation range information 430 which correspond to the lightness adjustment item 320, the contrast adjustment item 330, and the chroma adjustment item 340 and recording material consumption variation ranges of the pieces of recording material consumption variation range information 631-633 which correspond to the low-density adjustment item 621, the medium-density adjustment item 622, and the high-density adjustment item 623 are calculated for each print subject image (image data) and hence vary. Even if the image quality adjustment ranges of the respective image-quality-determining elements (lightness, contrast, chroma, color balance, etc.) are kept the same, the recording material consumption variation ranges corresponding to the respective image quality adjustment ranges vary depending on, for example, the patterns and the colors used of the print subject image.

As described above, in the first embodiment, the user performs a desired image quality adjustment(s) taking a consumption of the recording materials into consideration by visually recognizing a relationship between an image quality adjustment amount (a result of the image quality adjustment) and the consumption of the recording materials.

More specifically, recording material consumption variation range information is displayed which includes a decrease ratio and an increase ratio with respect to a consumption of the recording materials corresponding to a predetermined value (default setting value) of each of pieces of image quality information (image-quality-determining elements) is displayed so as to corresponding to an adjustment range of the piece of image information (image-quality-determining element). The user adjusts a desired image-quality-determining element taking the recording material consumption variation range information into consideration.

As described above, recording material consumption variation range information also includes an increase ratio with respect to a consumption of the recording materials corresponding to a predetermined value (default setting value) of each of pieces of image quality information (image-quality-determining elements). Therefore, even a user who does not aim at saving the recording materials can perform an image quality adjustment so as to suppress increase of the consumption of the recording materials by taking the recording material consumption variation range information into consideration.

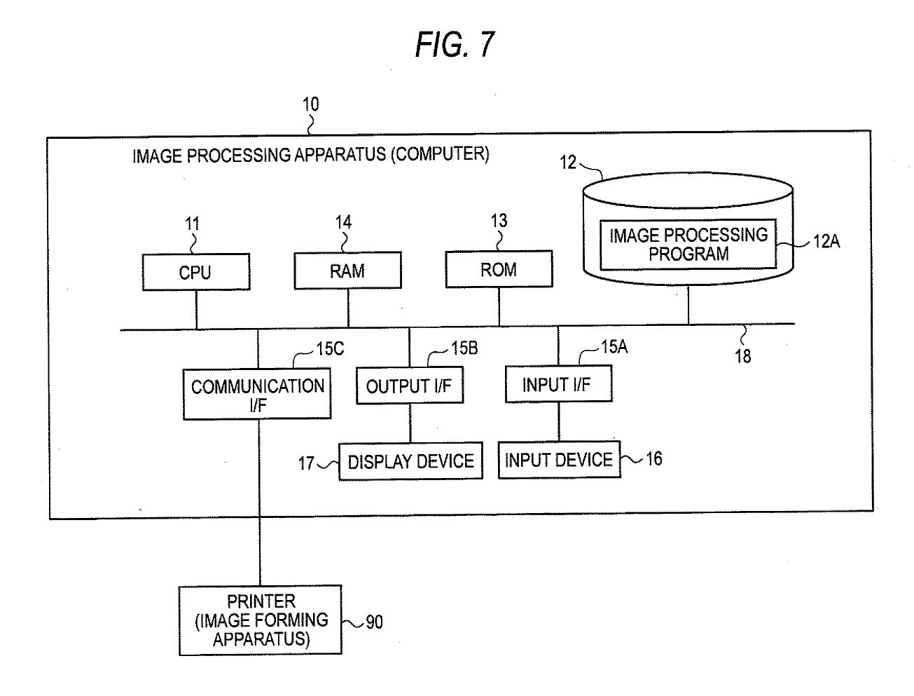

Next, a hardware configuration of the image processing apparatus 10 will be described with reference to FIG. 7.

As shown in FIG. 7, the image processing apparatus 10 is equipped with a CPU 11, a storage device 12, a ROM 13, a RAM 14, an input interface (I/F) 15A, an output I/F 15B, a communication I/F 15C, an input device 16 which is connected to the input I/F 15A, and a display device 17 which is connected to the output I/F 15B. The constituent elements 11-14 and 15A-15C are connected to a system bus 18.

The storage device 12, which is a hard disc drive, for example, is stored with installed programs such as an image processing program 12A and the GUI 102 and the application software 105 which are shown in FIG. 1.

The image processing program 12A includes software (programs) for implementation of the functions of the image processing section 100 (constituent elements 110-140; see FIG. 1) and software (program) corresponding to the image quality setting process (see FIG. 2).

The functions of the image processing section 100 (constituent elements 110-140) include the functions of the constituent elements 121-124 of the image analyzing section 120.

In the image processing section 100, the first calculating section 123 and the second calculating section 124 of the image analyzing section 120 executes a first calculation process and a second calculation process, respectively, and the control section 130 executes a control process.

The storage device 12 performs the function of the default print setting information storage unit 101 (see FIG. 1).

The ROM 13, which is a read-only memory, is stored with formula information corresponding to the equations of Formulae 1, communication protocol information which is necessary for communication with an external apparatus, and other information.

The RAM 14, which is a random access memory, stores programs including the image processing program 12A, the GUI 102, and the application software 105 which are read from the storage device 12, the default print setting information which is also read from the storage device 12, and the formula information and the communication protocol information which are read from the ROM 13.

The RAM 14 is assigned a storage area (work area) which is necessary for processing that is performed by the image processing section 100. An interim result or a final result of each of such pieces of processing as reduced image generation processing which is performed by the reduced image generating section 121, simulation processing which is performed by the simulation section 122, calculation processing which is performed by the first calculating section 123, calculation processing which is performed by the second calculating section 124, and control processing which is performed by the control section 130, print subject image data, print setting information, the image quality adjustment picture, the default print setting information which is read from the default print setting information storage unit 101 (storage device 12) by the image processing section 100, etc. are stored in the RAM 14.

Each of the input I/F 15A and the output I/F 15B is provided with a CPU (central processing unit) for performing a data communication. And the input I/F 15A performs a data communication with the input device 16 and the output I/F 15B performs a data communication with the display device 17. The input device 16 performs the functions of the input unit 103 (see FIG. 1) and the display device 17 performs the functions of the display unit 104 (see FIG. 1).

Provided with a CPU for performing a data communication, the communication I/F 15C performs a data communication with a printer (image forming apparatus) 90 by reading the above-mentioned communication protocol information into the RAM 14 from the ROM 13 and using it.

The CPU 11, which is a central processing unit, realizes the functions of the individual constituent elements of the image processing section 100 and the processing functions corresponding to the image processing program 12A by reading programs including the image processing program 12A into the RAM 14 from the storage device 12 and executing them. Furthermore, the CPU 11 controls the entire image processing apparatus 10.

### Second Embodiment

An image processing apparatus according to a second embodiment has the same functional configuration as the image processing apparatus according to the first embodiment shown in FIG. 1.

In the second embodiment, the control section 130 of the image processing section 100 has, in addition to the functions of the control section 130 of the first embodiment, a function of performing a control for displaying, on the display unit 104, information relating to a variation of the consumption of the recording materials that corresponds to each of plural options for each of setting items that affect the consumption of the recording materials other than the one or more image-quality-determining elements.

Example setting items that affect the consumption of the recording materials are a color mode, a print mode, an image quality adjustment mode, and an image quality type.

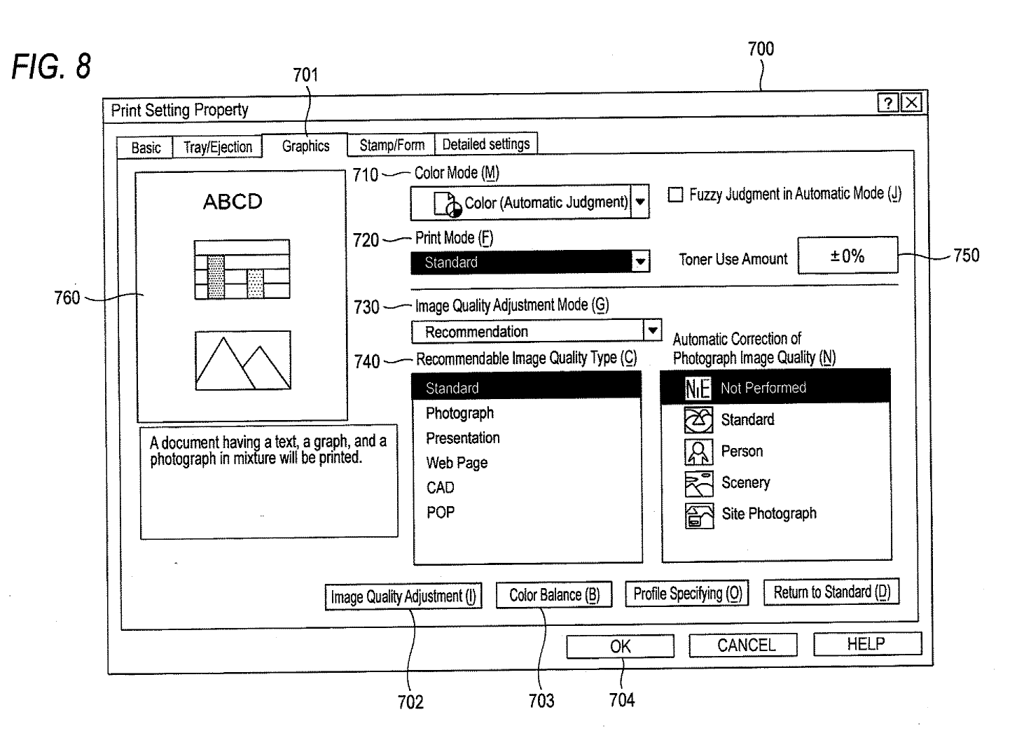

FIG. 8 shows example print setting property for changing those setting items.

The print setting property 700 of FIG. 8 is a picture of a default state that an item (tab) “graphics” 701 is selected, and contains setting items of a color mode 710, a print mode 720, an image quality adjustment mode 730, and a recommendable image quality type 740, an item of a toner use amount (toner consumption ratio) 750, and a reduced image 760. Setting modes and type of the setting items 710-740 are default modes and type and the setting value of the toner use amount (toner consumption ratio) 750 is a default setting value “0%.”

The print setting property 700 is also provided with an image quality adjustment button 702 for displaying an image quality adjustment picture, a color balance button 703 for displaying a color balance adjustment picture, and an OK button 704 for deciding on setting modes, type, value of the above setting items. If the image quality adjustment button 702 is pressed, the image quality adjustment picture 300 used in the first embodiment (see FIG. 3) is displayed on the display unit 104.

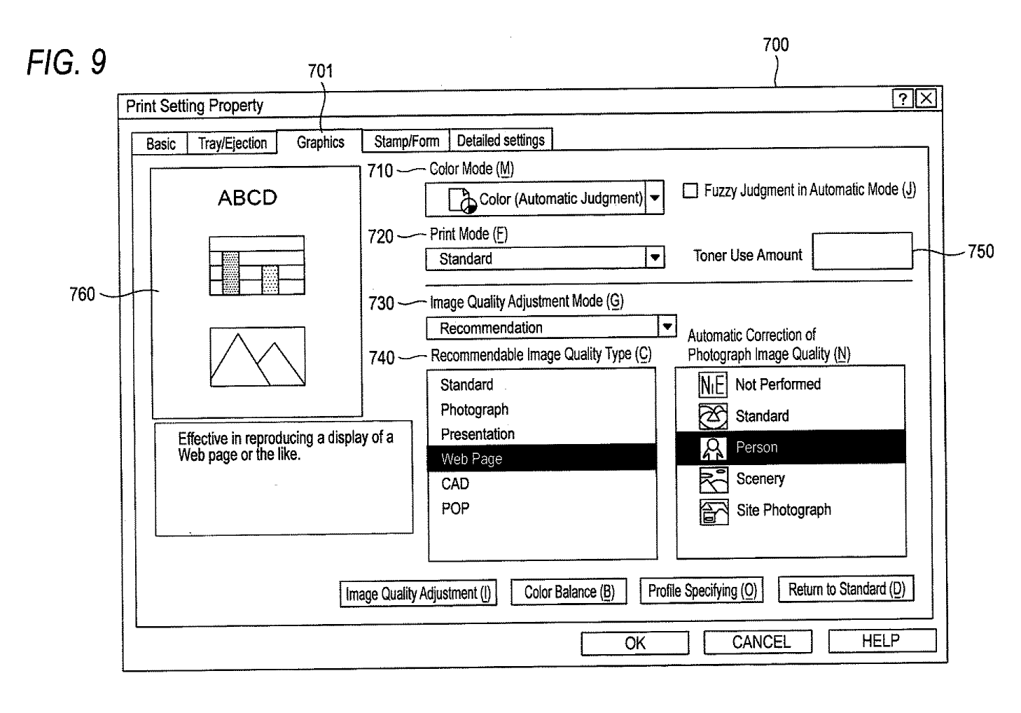

First, an example procedure for changing the setting type of the recommendable image quality type 740 will be described with reference to FIG. 9.

As shown in the example of FIG. 9, “Web page,” for example, is selected from options “standard (default),” “photograph,” “presentation,” “Web page,” “CAD,” and “POP” of the recommendable image quality type 740 in the picture 700 of FIG. 8, whereby the setting mode of the recommendable image quality type 740 is changed to “Web page.”

In this case, internal image processing in which importance is attached to display reproducibility is employed, and the information relating to a variation of the consumption of the recording materials, that is, the toner use amount (toner consumption ratio), varies accordingly. Therefore, a varied toner use amount (toner consumption ratio) is displayed in the item the toner use amount (toner consumption ratio) 750.

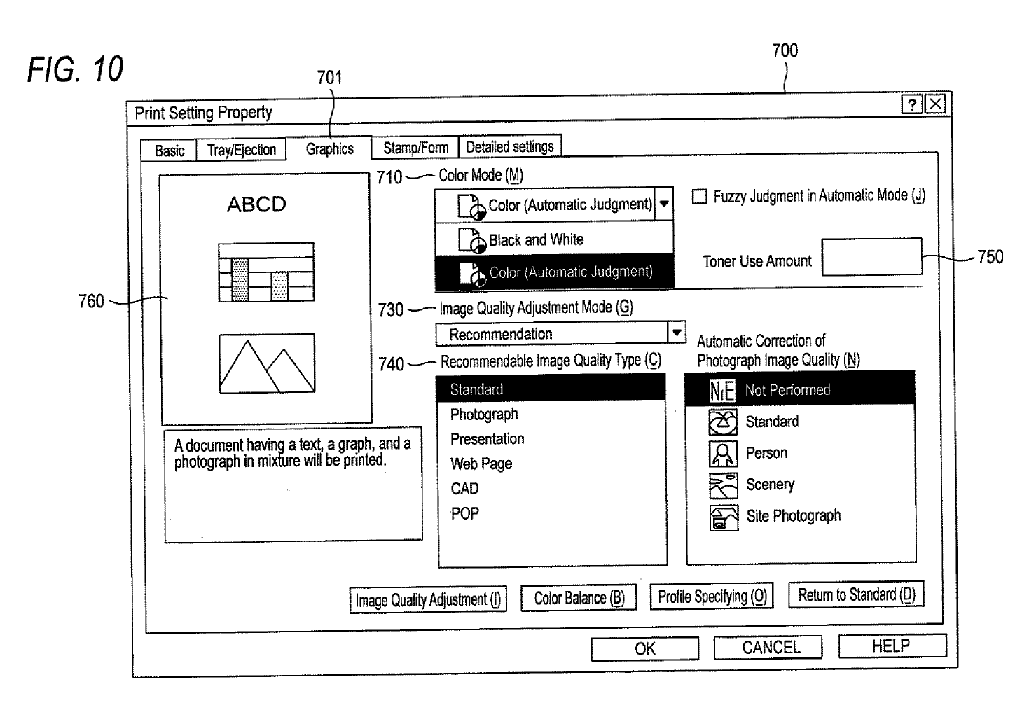

Next, an example procedure for changing the setting mode of the color mode 710 will be described with reference to FIG. 10.

As shown in the example of FIG. 10, switching is made between options “color (automatic judgment)” and “black and white” of the color mode 710 in the picture of FIG. 8. For example, where the print subject image is a color image, the setting mode of the color mode 710 is changed from “color (automatic judgment)” which is selected by automatic judgment to “black and white.” In this case, a color image is printed as a black-and-white image, and the information relating to a variation of the consumption of the recording materials, that is, the toner use amount (toner consumption ratio), varies accordingly. Therefore, a varied toner use amount (toner consumption ratio) is displayed in the item the toner use amount (toner consumption ratio) 750.

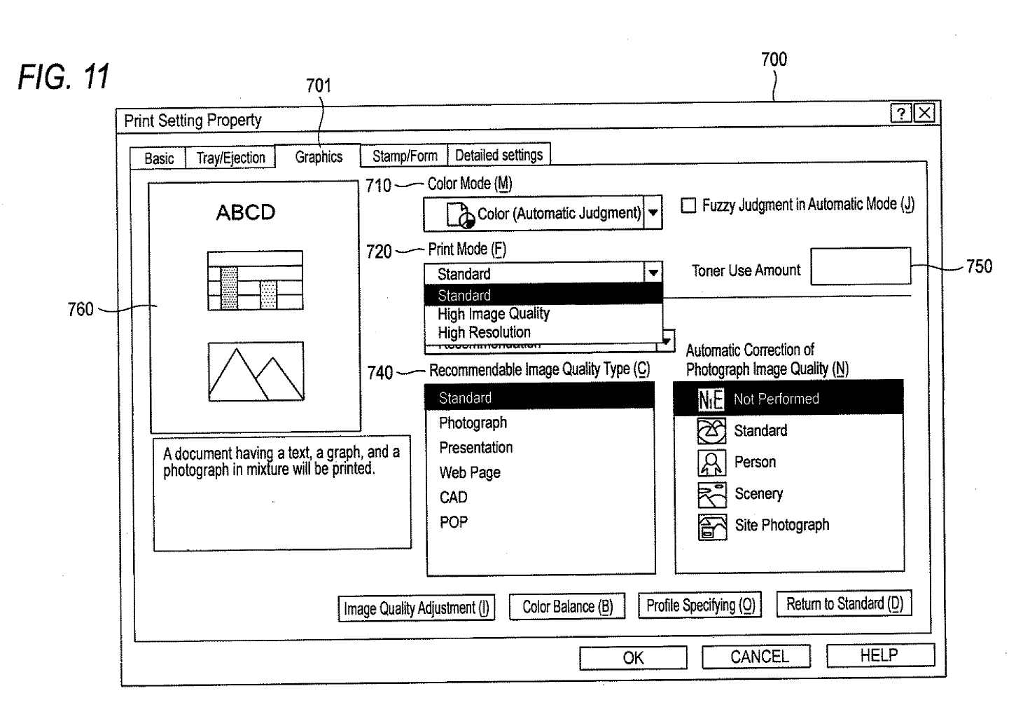

Next, an example procedure for changing the setting mode of the print mode 720 will be described with reference to FIG. 11.

As shown in the example of FIG. 11, a desired option is selected from options “standard,” “high image quality,” and “high resolution” of the print mode 720 in the picture of FIG. 8. In this case, the resolution of internal processing and the screen structure are changed according to a selected option, and the information relating to a variation of the consumption of the recording materials, that is, the toner use amount (toner consumption ratio), varies accordingly. Therefore, a varied toner use amount (toner consumption ratio) is displayed in the item the toner use amount (toner consumption ratio) 750.

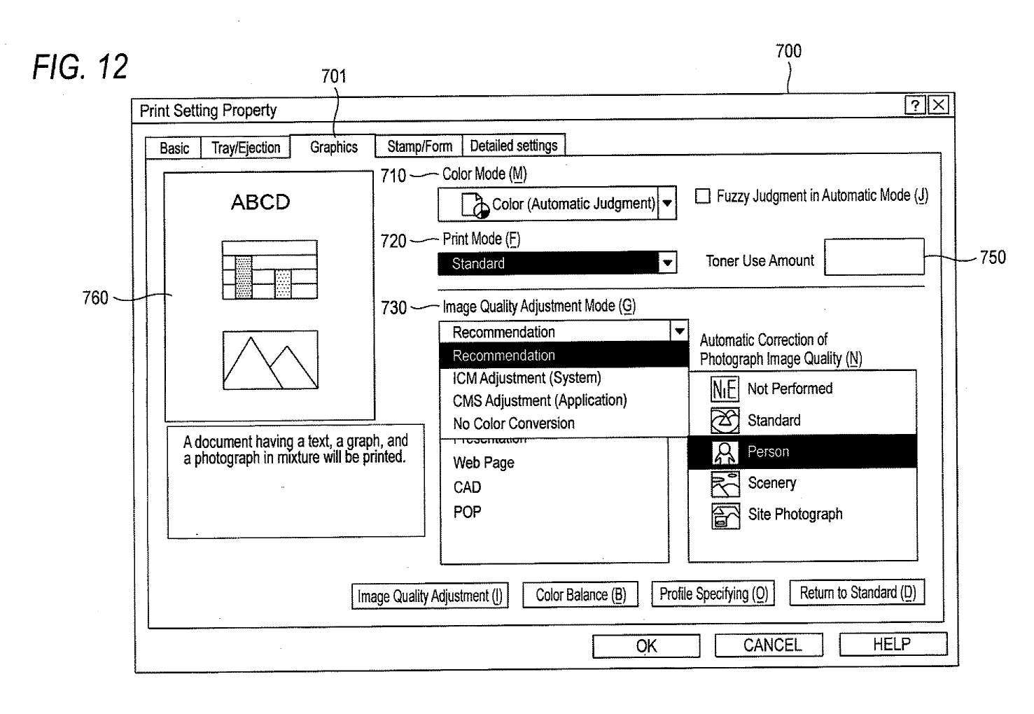

Finally, an example procedure for changing the setting mode of the image quality adjustment mode 730 will be described with reference to FIG. 12.

As shown in the example of FIG. 12, a desired option is selected from options “recommendation,” “ICM adjustment,” “CMS adjustment,” and “no color conversion” of the image quality adjustment mode 730 in the picture of FIG. 8. The color conversion profile depends on a selected option, and the toner use amount (toner consumption ratio), varies accordingly. Therefore, a varied toner use amount (toner consumption ratio) is displayed in the item the toner use amount (toner consumption ratio) 750.

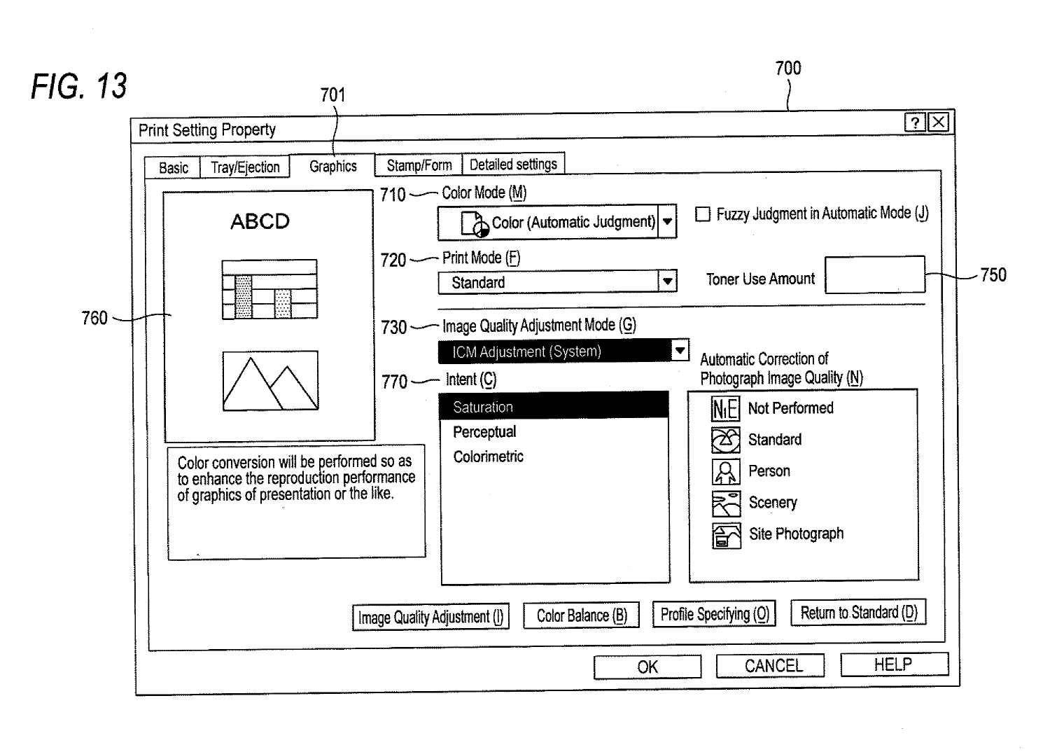

If “ICM adjustment” is selected and set as a setting mode of the image quality adjustment mode 730, as shown in FIG. 13 an item “intent” 770 for the image quality adjustment mode 730 is displayed and a desired option (color conversion method) is selected from options of the intent 770 (color conversion methods) “saturation,” “perceptual,” and “colorimetric.” The information relating to a variation of the consumption of the recording materials, that is, the toner use amount (toner consumption ratio), varies according to a selected option (color conversion method). Therefore, a varied toner use amount (toner consumption ratio) is displayed in the item the toner use amount (toner consumption ratio) 750.

If “ICM adjustment” is selected, color conversion is performed by using an ICM function of the printer driver, that is, the image processing section 100. A color conversion method is selected from the intent 770. In this case, an ICC profile corresponding to a printer (print destination) is specified using a tab “color management” (not shown).

If “CMS adjustment” is selected, color conversion is not performed by the printer driver, that is, the image processing section 100. Where an application having a dedicated CMS (color management system) makes print instructions, color data produced by a conversion that is suitable for the characteristics of a printer main body is given to the printer driver, that is, the image processing section 100. In this case, the item “CMS adjustment” should be selected to avoid double color conversions by the printer driver.

If “no color conversion” is selected, color conversion is not performed by the printer driver, that is, the image processing section 100 or an application. The printer main body does not perform any special color conversion processing and performs only a complementary color conversion.

Although the invention made by the present inventors has been described above using the embodiments, the embodiments disclosed in the specification are just examples in all respects and the invention should not be construed as being limited to the disclosed techniques. That is, the technical scope of the invention should not be construed restrictively based on the description of the embodiments and should be construed based on the claims, and encompasses techniques that are equivalent to the techniques described in the claims and all modifications that do not depart from the spirit and scope of the claims.

Where programs are used, they may be provided over a network or being stored in a storage medium such as a CD-ROM.

That is, the method for providing programs including the image processing program is not limited to storing them in a storage medium such as a hard disk drive, and they may be provided in the following manners.

For example, the programs may be provided in such a manner that they are stored in a ROM in advance and a CPU loads them into the main storage device from the ROM and runs them.

The programs may be distributed being stored in a computer-readable storage medium such as a DVD-ROM, a CD-ROM, an MO (magneto-optical disc), or a flexible disk.

Furthermore, a system may be provided in which an image processing apparatus or the like is connected to a server or a host computer via a communication line (e.g., the Internet) and the programs are downloaded from the server or the host computer and then run. In this case, example download destinations of the programs are a memory such as a RAM and a storage device (storage medium) such as a hard disk drive.

### INDUSTRIAL APPLICABILITY

The invention may be applied to an image processing apparatus which sends print data to an image forming apparatus which forms an image with toners (electrophotographic process type image forming apparatus) or an image forming apparatus which forms an image with inks (ink-jet image forming apparatus).

What is claimed is:

1. An image processing apparatus comprising:
a first calculating unit that calculates, for each print subject image, consumptions of recording materials when the print subject image is printed based on image data of the print subject image, a first value of a first element and a second value of a second element, the first element and the second element affecting image quality of the printed print subject image;
a second calculating unit that calculates a first consumption variation range of the recording materials that corresponds to a first adjustment range of the first element and a second consumption variation range of the recording materials that corresponds to a first adjustment range of the second element; and
a control unit that controls a display device so that the display device displays the first adjustment range and the first variation range to be correlated with each other and displays the second adjustment range and the second variation range to be correlated with each other.

2. The image processing apparatus according to claim 1, wherein when at least one of the first value and the second value is changed to a given value, the control unit calculates a total consumption variation ratio of the recording materials caused by the change of the first value and the second value and controls the display device so that the display device displays the total consumption variation ratio.

3. The image processing apparatus according to claim 1, wherein the control unit controls the display device so that the display device displays information indicating a guide for suppressing the consumptions of the recording materials with respect to a change of the first value and the second value.

4. The image processing apparatus according to claim 2, wherein the control unit controls the display device so that the display device displays information indicating a guide for suppressing the consumptions of the recording materials with respect to the change of the first value and the second value.

5. The image processing apparatus according to claim 1, wherein the control unit controls the display device so that the display device displays pieces of information of a variation of the consumptions of the recording materials with respect to plural respective options of a setting item that affects consumption of the recording materials other than the first element and the second element.]

6. The image processing apparatus according to claim 2, wherein the control unit controls the display device so that the display device displays pieces of information of a variation of the consumptions of the recording materials with respect to plural respective options of a setting item that affects consumption of the recording materials other than the first element and the second element.

7. The image processing apparatus according to claim 3, wherein the control unit controls the display device so that the display device displays pieces of information of a variation of the consumptions of the recording materials with respect to plural respective options of a setting item that affects consumption of the recording materials other than the first element and the second element.

8. The image processing apparatus according to claim 4, wherein the control unit controls the display device so that the display device displays pieces of information of a variation of the consumptions of the recording materials with respect to plural respective options of a setting item that affects consumption of the recording materials other than the first element and the second element.

9. A computer readable medium storing a program causing a computer to execute a process for image processing, the process comprising:
calculating, for each print subject image, consumptions of recording materials when the print subject image is printed based on image data of the print subject image, a first value of a first element and a second value of a second element, the first element and the second element affecting image quality of the printed print subject image;
calculating a first consumption variation range of the recording materials that corresponds to a first adjustment range of the first element and a second consumption variation range of the recording materials that corresponds to a first adjustment range of the second element;
displaying the first adjustment range and the first variation range to be correlated with each other; and
displaying the second adjustment range and the second variation range to be correlated with each other.

10. An image processing method comprising:
calculating, for each print subject image, consumptions of recording materials when the print subject image is printed based on image data of the print subject image, a first value of a first element and a second value of a second element, the first element and the second element affecting image quality of the printed print subject image;
calculating a first consumption variation range of the recording materials that corresponds to a first adjustment range of the first element and a second consumption variation range of the recording materials that corresponds to a first adjustment range of the second element;
displaying the first adjustment range and the first variation range to be correlated with each other; and
displaying the second adjustment range and the second variation range to be correlated with each other.
